(19) United States
(12) Patent Application Publication
(10) Pub. No.: US 2023/0151923 A1
(43) Pub. Date: May 18, 2023

(54) MEDIA BAR BRACKET

(71) Applicant: Bose Corporation, Framingham, MA (US)

(72) Inventors: Kevin Joseph Brousseau, Brighton, MA (US); Thomas E. MacDonald, Boston, MA (US); David L. Pepin, Sutton, MA (US)

(21) Appl. No.: 17/526,390

(22) Filed: Nov. 15, 2021

(51) Int. Cl. F16M 11/04; F16M 11/10; F16M 13/02

(52) U.S. Cl. CPC F16M 11/046; F16M 11/10; F16M 13/02

(57) ABSTRACT

Various implementations include brackets for mounting a media bar, and systems that includes a media bar and a bracket. The brackets can be configured to couple with at least two distinct external components, in distinct orientations. In certain examples, a bracket for mounting a media bar includes: a first section including a first set of mating features for coupling with the media bar; a second section including a second set of mating features for coupling with at least two distinct external components; and at least one hinge for adjusting the first section relative to the second section to enable mounting the media bar to the at least two distinct external components, respectively, in distinct orientations.

### TECHNICAL FIELD

This disclosure generally relates to brackets and holders. More particularly, the disclosure relates to brackets for a media bar.

### BACKGROUND

Conventional brackets for mounting media bars (e.g., audio bars, video bars, or audio/video bars) are configured for mounting in a single orientation and/or to a single type of external component. For example, certain conventional brackets are configured to mount the media bar to a wall (also referred to as a “wall mount”), while other conventional brackets are configured to mount the media bar to a tabletop or stand. Additionally, many conventional brackets position the media bar in a manner that negatively impacts audio and/or video pickup, e.g., causing acoustic and/or visual interference.

### SUMMARY

All examples and features mentioned below can be combined in any technically possible way.

Various implementations include a bracket for mounting a media bar, and a system that includes a media bar and a bracket. The bracket can be configured to couple with at least two distinct external components, in distinct orientations.

In particular aspects, a bracket for mounting a media bar includes: a first section including a first set of mating features for coupling with the media bar; a second section including a second set of mating features for coupling with at least two distinct external components; and at least one hinge for adjusting the first section relative to the second section to enable mounting the media bar to the at least two distinct external components, respectively, in distinct orientations.

In additional particular aspects, a system includes: a media bar; and a bracket for mounting the media bar to at least two distinct external components, the bracket including: a first section having a first set of mating features for coupling with the media bar; a second section having a second set of mating features for coupling with the at least two distinct external components; and at least one hinge for adjusting the first section relative to the second section to enable mounting the media bar to the at least two distinct external components in distinct orientations.

Implementations may include one of the following features, or any combination thereof.

In some cases, the first set of mating features includes a first subset of mating features for coupling with the media bar in a first one of the distinct orientations and a second subset of mating features for coupling with the media bar in a second one of the distinct orientations.

In particular aspects, each of the first subset and the second subset of mating features includes a plurality of apertures positioned to align with a plurality of corresponding mating features in the media bar.

In certain implementations, when coupled with the media bar, the first subset of mating features aligns the media bar at a first height relative to the first section and the second subset of mating features aligns the media bar at a second height relative to the first section.

In some cases, when mounted to an approximately vertical surface and aligned at the first height, the media bar substantially obstructs the bracket from view.

In particular implementations, when mounted to a non-vertical surface and aligned at the second height, the media bar is positioned a distance from the non-vertical surface and has an adjustable orientation between a plurality of the distinct orientations.

In certain aspects, when the bracket is mounted to the non-vertical surface via a stand resting on the non-vertical surface, a portion of the media bar is separated from the non-vertical surface by at least approximately 15 millimeters (mm).

In particular cases, the second set of mating features includes: a first subset of mating features for coupling with a first type of external component in a first one of the distinct orientations; and a second subset of mating features for coupling with a second type of external component in a second one of the distinct orientations.

In some implementations, the first type of external component includes an approximately vertical surface and the second type of external component includes a stand for resting on a non-vertical surface.

In certain cases, the second section further includes at least one tab for engaging a slot in the stand.

In particular aspects, the bracket enables at least one of: i) the media bar to be angled downward by up to approximately 10 degrees relative to the non-vertical surface, ii) the media bar to be angled upward by up to approximately 20 degrees relative to the non-vertical surface, iii) the media bar to be angled upward by up to approximately 20 degrees relative to a plane perpendicular to the approximately vertical surface, or iv) the media bar to be angled downward by up to approximately 90 degrees relative to the plane perpendicular to the approximately vertical surface.

In some implementations, the media bar is configured to be mounted to the stand with only one coupler.

In certain aspects, when coupled with the stand, the second subset of mating features maintains a gap between a bottom surface of the media bar the non-vertical surface.

In particular cases, the media bar includes a microphone, and the gap provides an acoustic enhancement for the media bar comprising at least one of: i) mitigation of low frequency feedback at the microphone from the non-vertical surface, or ii) mitigation of high volume feedback at the microphone from the non-vertical surface.

In some aspects, the first set of mating features are offset from the second set of mating features in at least one of a horizontal axis or a vertical axis of the bracket to prevent mounting of the media bar in an unintended orientation.

In particular implementations, the first section includes two distinct components or a single unitary component, where the first section includes a set of alignment tabs, wherein the first set of mating features and the alignment tabs are configured to align the media bar in one of the distinct orientations.

In certain aspects, the at least one hinge includes two distinct hinges coupling the first section and the second section, where the set of alignment tabs extend laterally beyond each of the two distinct hinges.

In particular implementations, the bracket further includes a cable lock slot in the second section for receiving a cable.

In some cases, the at least one hinge includes a friction hinge for maintaining a position of the first section relative to the second section.

In certain implementations, the media bar includes a camera, and the at least one hinge enables adjustment of a video capture angle of the camera.

In particular cases, the media bar includes a video bar having a camera.

In some aspects, the media bar includes a soundbar without a camera.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

FIG. 1 is first perspective view of a media bar bracket according to various implementations.

FIG. 2 is an additional perspective view of the media bar bracket of FIG. 1.

FIG. 3 is a perspective view of a media bar coupled with a media bar bracket according to various implementations.

FIG. 4 is a perspective view of a media bar coupled with a media bar bracket according to various additional implementations.

FIG. 5 shows a close-up perspective of a portion of a media bar bracket and corresponding rear views of a media bar bracket coupled to a media bar according to various implementations.

FIG. 6 is a side view of a media bar coupled with a bracket and a stand according to various implementations.

FIG. 7 is a side view of a media bar coupled with a bracket and an approximately vertical surface according to various implementations.

FIG. 8 shows angle adjustment of the media bar bracket of FIG. 7 according to various implementations.

FIG. 9 shows angle adjustment of the media bar brackets of FIGS. 7 and 8 according to various implementations.

FIG. 10 is a side view of a media bar coupled with a bracket and a stand according to various implementations.

FIG. 11 shows angle adjustment of the media bar bracket of FIG. 10 according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that a media bar bracket can be configured with two sections enabling mounting of a media bar to at least two distinct external components, in distinct orientations. A first section of the bracket can include a first set of mating features for coupling with the media bar, and the second section can include a second set of mating features for coupling with at least two distinct external components.

As noted herein, conventional media bar brackets are configured to mount a media bar to a single type of external component and/or in a single orientation. For example, media bars are often sold with, or paired with, multiple brackets for mounting to distinct types of external components, namely: a wall or other approximately vertical mounting bracket, and a tabletop or other non-vertical mounting bracket. Additionally, these conventional brackets can be limited in their degrees of adjustment, contributing to issues of acoustic and/or visual interference. In contrast to these conventional media bar brackets, various implementations include a single bracket that is configured to mount to distinct external components in distinct orientations. As such, a user can mount a media bar with the brackets disclosed herein to distinct types of external components (e.g., wall mount, upright mount, table stand, tabletop, etc.) in multiple orientations. The brackets disclosed according to various implementations also enable access to media bar connectors and/or controls while mounted, and can enable efficient switching of orientation and/or mounting configuration with the single bracket.

Commonly labeled components in the FIGURES are considered to be substantially equivalent components for the purposes of illustration, and redundant discussion of those components is omitted for clarity. Numerical ranges and values described according to various implementations are merely examples of such ranges and values, and are not intended to be limiting of those implementations. In some cases, the term “approximately” is used to modify values, and in these cases, can refer to that value+/−a margin of error, such as a measurement error, which may range from up to 1-5 percent. With reference to angle values (e.g., in degrees), the term “approximately” can refer to that angle value+/−a margin of error which can range from one degree to two degrees.

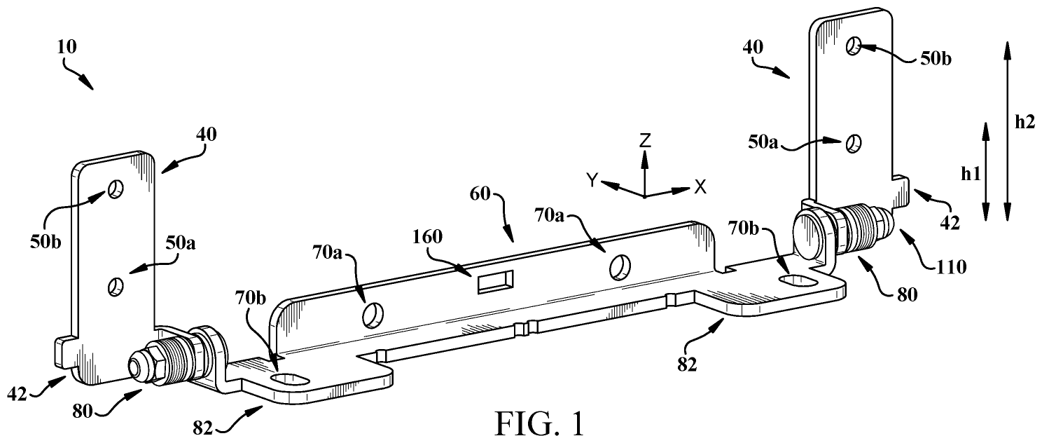

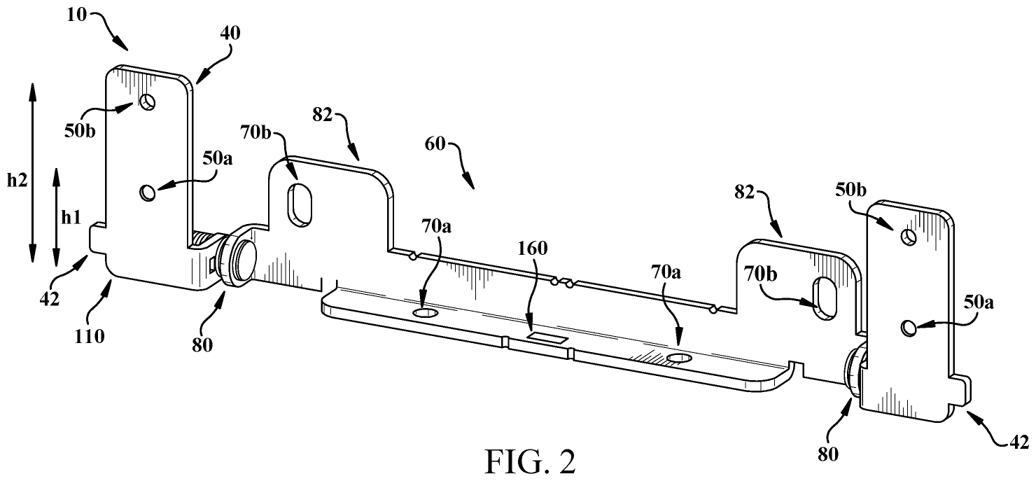

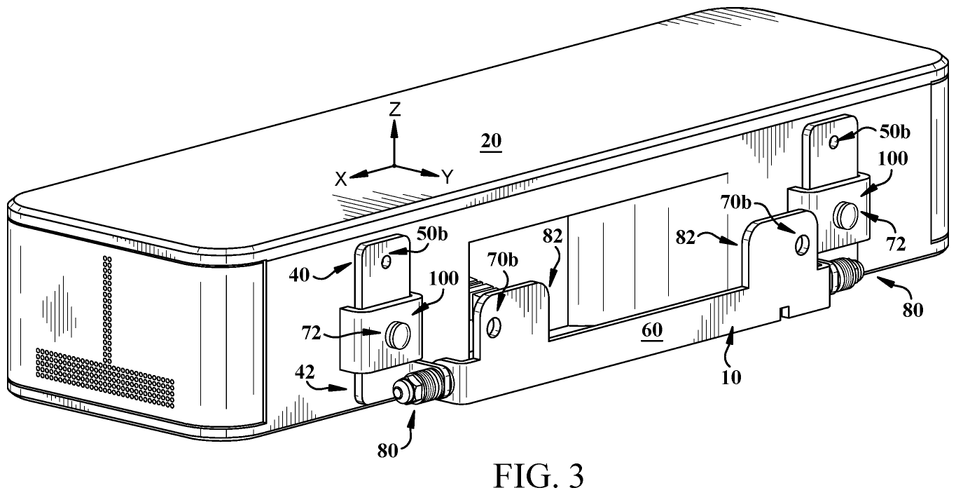

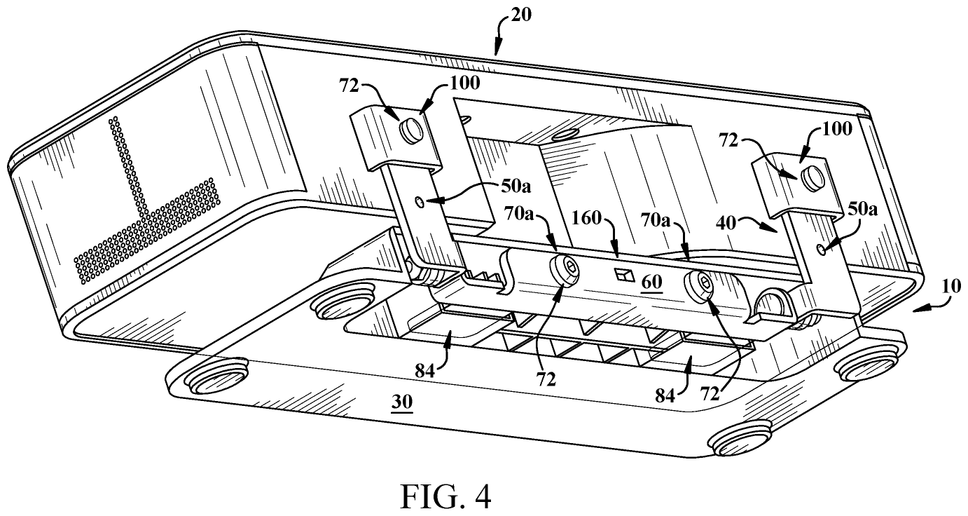

FIG. 1 depicts a first perspective view of a media bar bracket (or simply, bracket) 10 according to various implementations. FIG. 2 shows a distinct perspective view of the bracket 10 of FIG. 1. FIG. 3 shows the bracket 10 coupled with a media bar 20 in a first orientation, and FIG. 4 shows the bracket 10 coupled with the media bar 20 in a second, distinct orientation. FIG. 4 illustrates an optional stand 30, such as a tabletop or other surface stand, to which the bracket 10 is coupled in this depiction. FIGS. 1-4 are referred to collectively.

As described herein, the media bar 20 can include an audio and/or video input/output component commonly referred to as a soundbar, a video bar, or a multimedia bar. In various implementations, the media bar 20 can include at least one microphone (e.g., a microphone array), one or more cameras, and/or one or more audio/visual interface components for providing captured audio and/or video to an external system (e.g., a communications system and/or a display). In certain cases, communications components and/or display components are integrated with or otherwise coupled with the media bar 20. In various implementations, the bracket 10 is sized to mount the media bar 20, e.g., in a suspended manner and/or on a stand. Examples of soundbars and/or multimedia bars can include those provided by Bose Corporation of Framingham, Mass., such as the Bose Videobar VB1, the Bose Smart Soundbar 300, the Bose Smart Soundbar 700, the Bose Smart Soundbar 900, and the Bose TV Speaker. In various implementations, the bracket 10 can include an accessory bracket that is mounted to, or is configured to mount to, e.g., a visual display system such as television, monitor, screen or other display.

Returning to the Figures, the bracket 10 is shown having a first section 40 with a first set of mating features 50 for coupling with the media bar 20. The bracket 10 also includes a second section 60 with a second set of mating features 70 for coupling with at least two distinct external components, e.g., in a wall-mounted configuration, a tabletop configuration, etc. The bracket 10 can also include at least one hinge 80 (example of two shown) for adjusting the first section 40 relative to the second section 60. The hinge(s) 80 enable adjustment of the first section 40 relative to the second section 60, for example, to enable mounting the media bar 20 to distinct external components, respectively, in distinct orientations. In certain cases, the hinge(s) 80 include a friction hinge for maintaining a position of the first section 40 relative to the second section 60. In certain example implementations, the first section 40 includes two distinct components, that is, two physically distinct components that are each coupled with the second section 60 by respective hinges 80. In other example implementations (not shown), the first section 40 is a single unitary component that is coupled with the second section 60 by one or more hinges 80. In certain of these examples, the first section 40 is coupled with the second section 60 by a single hinge 80.

In certain cases, the bracket 10 enables mounting the media bar 20 in two or more orientations, and in particular cases, up to three, four, five or more orientations. In some cases, the orientations are characterized in part by the type of external component to which the bracket 10 is mounted, which can dictate the mounting angle of the bracket and/or the media bar 20. In particular cases, the external component includes an approximately vertical surface. In additional cases, the external component includes a non-vertical surface and/or a stand for resting on a non-vertical surface. In certain cases, the distinction between an approximately vertical surface and a non-vertical surface is 70 degrees (e.g., measured from a horizontal plane), 80 degrees, 90 degrees, 100 degrees or 110 degrees. In particular cases, the term “approximately” modifies values by up to several percent, e.g., two, three, four, five percent. In some examples, the non-vertical surface is approximately horizontal, e.g., approximately parallel to a floor, ground surface, etc., in a room or space in which the bracket 10 is mounted.

The first set of mating features 50 can include a first subset of mating features (or simply, first subset) 50a and a second subset of mating features (or simply, second subset) 50b. The first subset 50a can be configured to couple with the media bar 20 in a first one of the orientations, e.g., to mount to an approximately vertical surface such as a wall, approximately vertical stand, or vertically faced protrusion. FIG. 3 illustrates the media bar 20 coupled with the first subset 50a in a first orientation, such as an approximately vertically mounted orientation. The second subset 50b can be configured to couple with the media bar 20 in a second one of the orientations, e.g., to mount to a non-vertical surface, such as a tabletop or a stand for resting on a non-vertical surface.

The second set of mating features 70 can include a first subset of mating features (or simply, first subset) 70a for coupling with a first type of external component in a first one of the (plurality of) orientations, and a second subset of mating features (or simply, second subset) 70b for coupling with a second type of external component in a second one of the (plurality of) orientations. As described herein, in some examples, the first type of external component can include an approximately vertical surface, and the second type of external component can include a stand for resting on a non-vertical surface or a non-vertical surface itself. In some implementations, the first subset 70a differs from the second subset 70b of mating features in terms of size and/or shape, e.g., where the first subset 70a includes a set of (e.g., one or more) apertures sized to receive a coupler 72 such as a mating pin, screw, bolt, tab or protrusion (FIG. 4) for coupling with a stand. In these cases, the second subset 70b can include a set of (e.g., one or more) apertures sized to engage a mounting pin, screw, bolt, tab or protrusion for coupling with the approximately vertical surface (e.g., FIG. 3). In certain implementations, e.g., as illustrated in FIGS. 1-4, the second section 60 can include at least one tab 82, e.g., for engaging a slot 84 in a stand and/or engaging a non-vertical surface. While multiple mating features and couplers are illustrated, e.g., in FIGS. 3 and 4, in particular examples, the media bar 20 is configured to be mounted to the bracket 10 with a single coupler, and/or the bracket 10 is configured to be mounted to the external component (e.g., stand and/or wall) with a single coupler.

In various implementations, the first set of mating features 50 are offset from the second set of mating features 70 in at least one of a horizontal axis or a vertical axis of the bracket 10. For example, as illustrated in FIGS. 1 and 2, the first set of mating features 50 is located at a distinct horizontal and/or vertical location relative to the bracket 10 as compared with the second set of mating features 70. In the particular example of FIGS. 1 and 2, the first set of mating features 50 is both vertically and horizontally offset from the second set of mating features 70. In more particular cases, the first set of mating features 50 are offset from the second set of mating features 70 in three dimensions, e.g., such that the second set of mating features 70 are each on distinct planes. In certain implementations, the horizontal and/or vertical offset between the mating features 50, 70 prevents mounting of the media bar 20 in an unintended orientation. That is, when the media bar 20 is engaged with one of the sets of mating features 50, 70, the other set of mating features is positioned to engage the external component in a desired orientation.

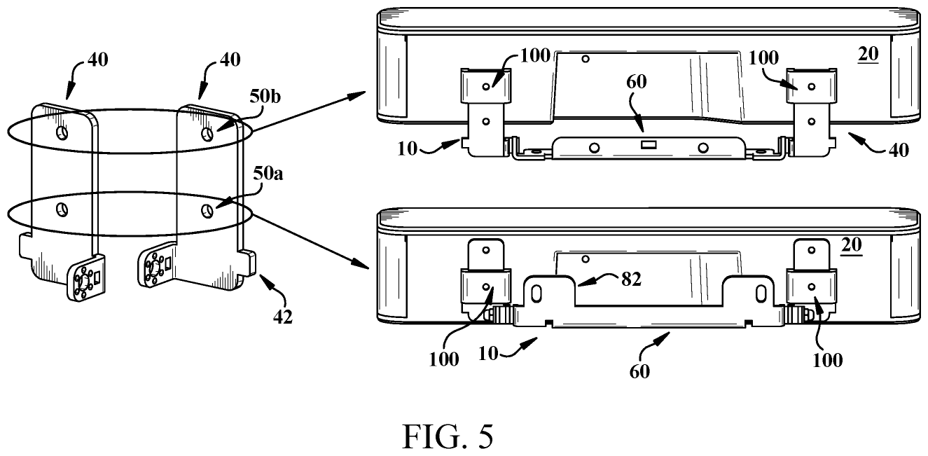

FIG. 4 illustrates the media bar 20 coupled with the second subset 50b in a second orientation, e.g., where the bracket 10 is coupled with a stand 30 for resting on a non-vertical surface. FIG. 5 is a mapping showing the relationship between both subsets 50a, 50b of mating features 50 and the media bar 20 in the second orientation, and the first orientation, respectively.

In various implementations, the first set of mating features 50 of the bracket 10 include a plurality of apertures positioned to align with a plurality of corresponding mating features 100 on the media bar 20. In certain cases, the apertures on the bracket 10 are configured to receive a mounting pin, screw, tab, etc. that either extends from the media bar 20 or otherwise engages a corresponding aperture on the media bar 20. Various alternative mating features can be used according to the implementations, for example, a set of male and/or female mating features can be used to couple the respective subsets 50a, 50b of mating features 50 of the bracket 10 with the mating features 100 on the media bar 20. In particular cases, the apertures are positioned to align with the mating features 100 in the media bar 20. For example, when coupled with the media bar 20, the first subset 50a aligns the media bar 20 at a first height (h₁) relative to the first section 40 (e.g., relative to an elbow 110 of the first section 40), and the second subset 50b aligns the media bar 20 at a second height (h₂) relative to the first section 40 (e.g., relative to elbow 110). In particular cases, the second height is greater than the first height.

In particular cases, the first section 40 also includes a set of alignment tabs 42 for aligning the media bar 20 in one of the distinct orientations. In particular cases, the set of alignment tabs 42 each extend laterally beyond the hinge(s) 80, e.g., to limit movement of the media bar 20 relative to the first section 40. FIG. 3 and the lower right-hand portion of FIG. 5 illustrate the alignment tabs 42 maintaining a position of the media bar 20 relative to the bracket 10, e.g., for mounting to an approximately vertical surface.

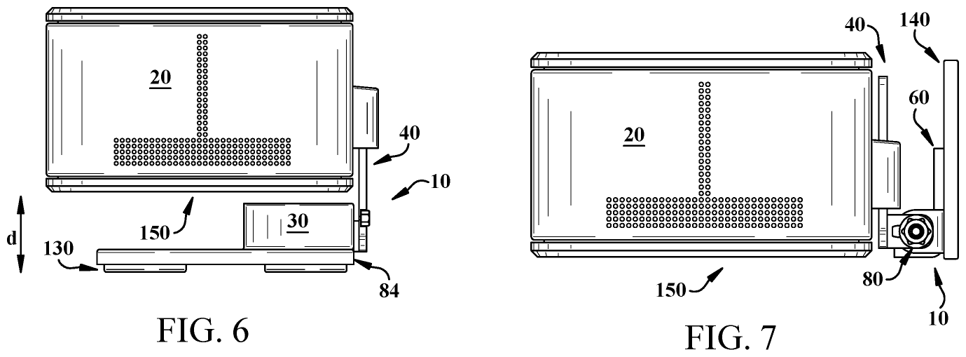

FIGS. 6 and 7 illustrate example side views of the media bar 20 and bracket 10, along with a stand 30 (FIG. 6) for mounting on a non-vertical surface 130 such as a tabletop, desktop, counter, console, shelf, automobile console, etc., and an approximately vertical surface 140 (FIG. 7) such as a wall, approximately vertical mount, a side panel, etc. As is further illustrated in these side views, when mounted to the approximately vertical surface 140 and aligned at the first height (h1), the media bar 20 substantially obstructs the bracket 10 from view, e.g., from a user or other observer with a line of sight approximating a height of the media bar 20. That is, the bracket 10 is not easily viewed by a user and/or observer in the approximately vertical mounting configuration. In a number of typical mounting configurations, e.g., when the media bar is mounted 20 above the user or below the user and the bracket 10 is angled toward the user (e.g., downward or upward, respectively), the media bar 20 obstructs the bracket from view across a range of angles.

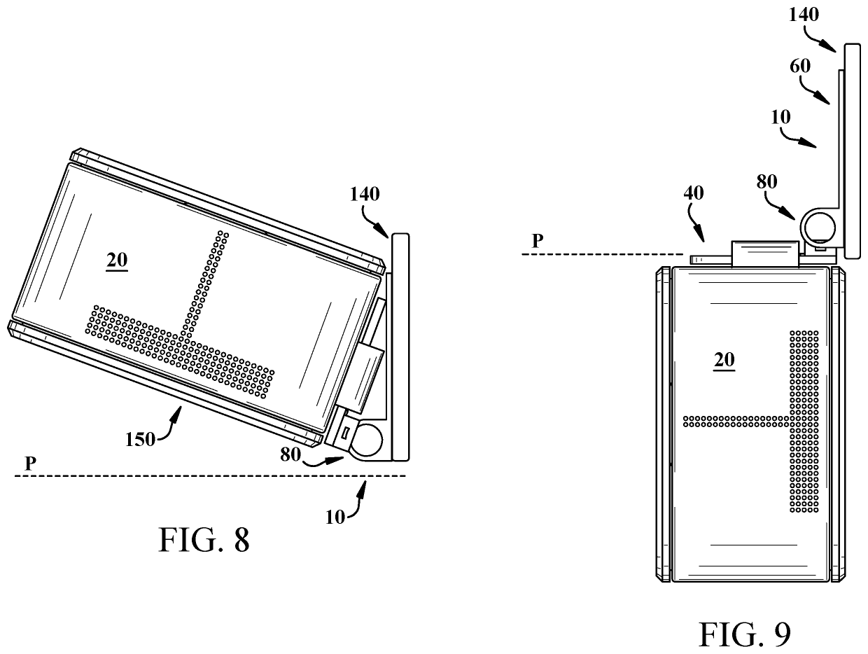

FIGS. 8 and 9 illustrate the ability of the bracket 10 to angle the media bar 20 upward or downward relative to a plane (P) that is perpendicular to the approximately vertical surface 140. In these examples, the media bar 20 can be angled upward by up to approximately 20 degrees relative to the plane (P), as illustrated in FIG. 8. In the example of a media bar 20 that includes video and/or audio pickup capability, the upward angle can be beneficial, for example, where the bracket 10 is mounted at or below the level of a user's head, e.g., to improve the directivity of the camera and/or microphones in the media bar 20. Additionally, angling of the bracket 10 can improve audio output functions, e.g., by directing transducer(s) in the media bar 20 toward one or more users in a space. The bracket 10 can also enable angling the media bar 20 downward relative to the plane (P), such as where the bracket 10 is mounted at or above the level of a user's head, e.g., to improve camera and/or microphone directivity. In certain cases, as illustrated in the example depicted in FIG. 9, the media bar 20 can be angled downward by up to approximately 90 degrees relative to the plane (P). This severe angle can allow a user to access the rear portion of the media bar 20 while the media bar 20 remains mounted to the bracket 10 and the approximately vertical surface 140. In these cases, the user can adjust controls at the rear of the media bar 20, adjust wiring and/or other connections at the rear of the media bar 20, etc., without dismounting the media bar 20 from the bracket 10 and/or the approximately vertical surface 140.

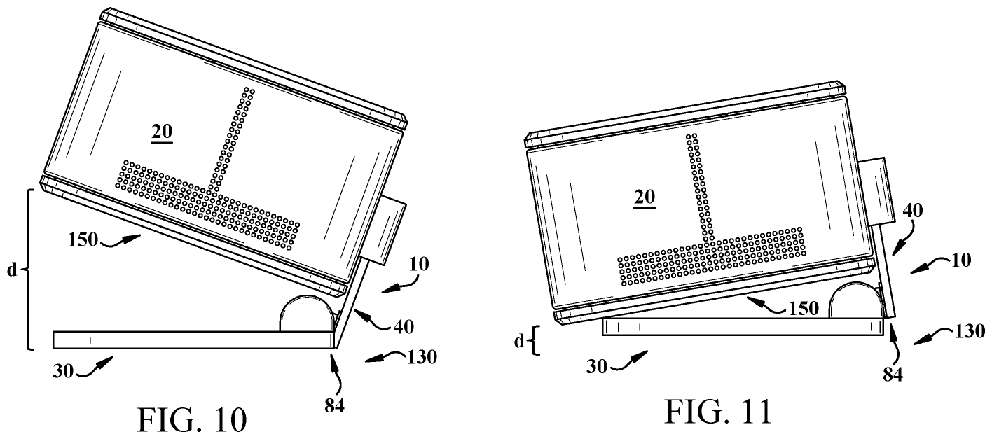

Returning to FIG. 6, when mounted to a non-vertical surface 130 (e.g., via stand 30) and aligned at the second height (h₂), the media bar 20 is positioned at a distance (d) from the non-vertical surface 130 and has an adjustable orientation between a plurality of distinct orientations. For example, FIGS. 10 and 11 illustrate distinct orientations of the media bar 20 relative to the non-vertical surface 130, while maintaining a minimum distance (d) of approximately 10-12 millimeters (mm). In certain cases, such as shown in an approximately zero degree angled position in FIG. 6, distance (d) is approximately 20-22 mm (e.g., approximately 21 mm). FIG. 10 shows an upward angled position where distance (d) is approximately 42-48 mm (e.g., approximately 45 mm). FIG. 11 shows a downward angled position where distance (d) is approximately 10-12 mm (e.g., approximately 11 mm). In some cases, the adjustable angle of the bracket 10 enables the media bar 20 to be angled upward (relative to the non-vertical surface 130) by up to approximately 20 degrees (FIG. 10), and angled downward (relative to the non-vertical surface 130) by up to approximately 10 degrees (−10 degree angle), as shown in FIG. 11. In particular cases, as shown in FIG. 11, the bracket 10 enables the media bar 20 to be angled downward by up to approximately 10 degrees (−10 degree angle) with distance (d) equal to at least approximately 10-12 mm. The ability to change the angle of the media bar 20, particularly in the non-vertical surface 130 mounting configuration, can enhance video and/or audio capture capabilities, as well as audio output capabilities. In particular cases, video capture capabilities are significantly improved by the adjustable angle of the bracket 10 in the non-vertical surface mounting configuration. For example, when the media bar 20 includes video capture capabilities (e.g., a camera system) and when mounted to a stand or tabletop, users of the media bar 20 are likely to be within close proximity of the media bar 20. In such cases, even small adjustments to the angle of the camera system in the media bar 20 can significantly enhance video capture capabilities. Even further, the ability to adjust the angle of the media bar 20 with a manual, friction hinge such as hinge 80, enables efficient and consistent angling of the media bar 20 relative to users in a space (e.g., a conference room, office, living space, entertainment venue, etc.). That is, as compared with remote controlled camera and/or microphone systems that can lose power, fail due to faulty communication components and/or signal interference, the bracket 10 is manually adjustable across a range of angles and maintains the desired angle with the friction hinge(s) 80.

As is further illustrated in FIGS. 10 and 11, in the stand-mounted configuration, the stand 30 prevents misalignment of the mating features 50 by preventing coupling with the first set of mating features 50b. That is, the stand 30 can interfere with a bottom surface of the media bar 20 if the media bar 20 is moved too far down the first section 40, such that the media bar 20 is only able to mount to the second set of mating features 50b in the stand-mounted configuration. As noted herein, when coupled with the stand 30, the second set of mating features 50b maintains the gap (distance (d)) between the bottom surface 150 of the media bar 20 and the non-vertical surface 130. In certain implementations, the gap maintained by the second set of mating features 50b provides an acoustic enhancement for the media bar 20 including at least one of: i) mitigation of low frequency feedback at the microphone from the non-vertical surface, or ii) mitigation of high volume feedback at the microphone from the non-vertical surface.

In addition to the various features of the bracket 10 that enable mounting the media bar 20 in desired orientations and to desired external components, the bracket 10 can also include additional features the enable access to the media bar 20, for example, an open design configuration. Further, in certain cases, the bracket 10 can include one or more slots or openings for enabling connection(s) with the media bar 20. In some examples, such as depicted in 1, 2 and 4, the bracket 10 can include a cable lock slot 160 in the second section 60 for receiving a cable or other connector. In certain cases, the cable lock slot 160 enables connection of a cable while mitigation tension on the cable caused by positioning of the media bar 20.

While various components in the brackets 10 are described as separate, it is understood that one or more components of the bracket(s) 10 can be formed as a unitary component, i.e., formed as a single component, such as through an additive manufacturing process, casting, molding, etc. In other cases, components can be is composed of separately formed parts that are bound together, e.g., with adhesive, heat staking, bonding, or via direct couplers or fasteners such as pins, clips, screws, etc.

One or more components in the devices described herein can be formed of any conventional mounting device material, e.g., a heavy plastic, metal (e.g., aluminum, steel, or alloys such as alloys of aluminum or steel), composite material, etc. It is understood that the relative proportions, sizes and shapes of the brackets 10 and components and features thereof as shown in the FIGURES included herein can be merely illustrative of such physical attributes of these components. That is, these proportions, shapes and sizes can be modified according to various implementations to fit a variety of products.

In various implementations, components described as being “coupled” to one another can be joined along one or more interfaces. In some implementations, these interfaces can include junctions between distinct components, and in other cases, these interfaces can include a solidly and/or integrally formed interconnection. That is, in some cases, components that are “coupled” to one another can be simultaneously formed to define a single continuous member. However, in other implementations, these coupled components can be formed as separate members and be subsequently joined through known processes (e.g., soldering, fastening, ultrasonic welding, bonding).

A number of implementations have been described. Nevertheless, it will be understood that additional modifications may be made without departing from the scope of the inventive concepts described herein, and, accordingly, other implementations are within the scope of the following claims.

We claim:

1. A bracket for mounting a media bar, the bracket comprising:
a first section comprising a first set of mating features for coupling with the media bar;
a second section comprising a second set of mating features for coupling with at least two distinct external components; and
at least one hinge for adjusting the first section relative to the second section to enable mounting the media bar to the at least two distinct external components, respectively, in distinct orientations.

2. The bracket of claim 1, wherein the first set of mating features comprises a first subset of mating features for coupling with the media bar in a first one of the distinct orientations and a second subset of mating features for coupling with the media bar in a second one of the distinct orientations.

3. The bracket of claim 2, wherein each of the first subset and the second subset of mating features comprises a plurality of apertures positioned to align with a plurality of corresponding mating features in the media bar.

4. The bracket of claim 2, wherein when coupled with the media bar, the first subset of mating features aligns the media bar at a first height relative to the first section and the second subset of mating features aligns the media bar at a second height relative to the first section.

5. The bracket of claim 4, wherein when mounted to an approximately vertical surface and aligned at the first height, the media bar substantially obstructs the bracket from view.

6. The bracket of claim 4, wherein when mounted to a non-vertical surface and aligned at the second height, the media bar is positioned a distance from the non-vertical surface and has an adjustable orientation between a plurality of the distinct orientations.

7. The bracket of claim 6, wherein when the bracket is mounted to the non-vertical surface via a stand resting on the non-vertical surface, a portion of the media bar is separated from the non-vertical surface by at least approximately 15 millimeters (mm).

8. The bracket of claim 1, wherein the second set of mating features comprises:
a first subset of mating features for coupling with a first type of external component in a first one of the distinct orientations; and
a second subset of mating features for coupling with a second type of external component in a second one of the distinct orientations.

9. The bracket of claim 8, wherein the first type of external component comprises an approximately vertical surface and wherein the second type of external component comprises a stand for resting on a non-vertical surface.

10. The bracket of claim 9, wherein the second section further comprises at least one tab for engaging a slot in the stand.

11. The bracket of claim 9, wherein the bracket enables at least one of:
i) the media bar to be angled downward by up to approximately 10 degrees relative to the non-vertical surface,
ii) the media bar to be angled upward by up to approximately 20 degrees relative to the non-vertical surface,
iii) the media bar to be angled upward by up to approximately 20 degrees relative to a plane perpendicular to the approximately vertical surface, or
iv) the media bar to be angled downward by up to approximately 90 degrees relative to the plane perpendicular to the approximately vertical surface.

12. The bracket of claim 9, wherein the media bar is configured to be mounted to the stand with only one coupler.

13. The bracket of claim 9, wherein when coupled with the stand, the second subset of mating features maintains a gap between a bottom surface of the media bar the non-vertical surface.

14. The bracket of claim 13, wherein the media bar comprises a microphone, and wherein the gap provides an acoustic enhancement for the media bar comprising at least one of: i) mitigation of low frequency feedback at the microphone from the non-vertical surface, or ii) mitigation of high volume feedback at the microphone from the non-vertical surface.

15. The bracket of claim 1, wherein the first set of mating features are offset from the second set of mating features in at least one of a horizontal axis or a vertical axis of the bracket to prevent mounting of the media bar in an unintended orientation.

16. The bracket of claim 1, wherein the first section comprises two distinct components or a single unitary component, wherein the first section comprises a set of alignment tabs, wherein the first set of mating features and the alignment tabs are configured to align the media bar in one of the distinct orientations.

17. The bracket of claim 16, wherein the at least one hinge comprises two distinct hinges coupling the first section and the second section, wherein the set of alignment tabs extend laterally beyond each of the two distinct hinges.

18. The bracket of claim 1, further comprising a cable lock slot in the second section for receiving a cable.

19. The bracket of claim 1, wherein the at least one hinge comprises a friction hinge for maintaining a position of the first section relative to the second section.

20. The bracket of claim 1, wherein the media bar comprises a camera, and wherein the at least one hinge enables adjustment of a video capture angle of the camera.

21. A system comprising:
a media bar; and
a bracket for mounting the media bar to at least two distinct external components, the bracket comprising:
a first section comprising a first set of mating features for coupling with the media bar;
a second section comprising a second set of mating features for coupling with the at least two distinct external components; and
at least one hinge for adjusting the first section relative to the second section to enable mounting the media bar to the at least two distinct external components in distinct orientations.

22. The system of claim 21, wherein the first set of mating features comprises a first subset of mating features for coupling with the media bar in a first one of the distinct orientations and a second subset of mating features for coupling with the media bar in a second one of the distinct orientations.

23. The system of claim 21, wherein the second set of mating features comprises:
a first subset of mating features for coupling with a first type of external component in a first one of the distinct orientations; and
a second subset of mating features for coupling with a second type of external component in a second one of the distinct orientations,
wherein the first type of external component comprises an approximately vertical surface and wherein the second type of external component comprises a stand for resting on a non-vertical surface.

24. The system of claim 21, wherein the media bar comprises a video bar having a camera.

25. The system of claim 21, wherein the media bar comprises a soundbar without a camera.
